(19) United States
(12) Patent Application Publication
(10) Pub. No.: US 2013/0268312 A1
(43) Pub. Date: Oct. 10, 2013

(54) Digital Asset Management Protocol

(71) Applicants: Nityanand Sharma, Tampa, FL (US); Sutap Chatterjee, Tampa, FL (US); Manoj Thankappan, Tampa, FL (US); Maxy Sebastian, Wesley Chapel, FL (US)

(72) Inventors: Nityanand Sharma, Tampa, FL (US); Sutap Chatterjee, Tampa, FL (US); Manoj Thankappan, Tampa, FL (US); Maxy Sebastian, Wesley Chapel, FL (US)

(73) Assignee: VERIZON PATENT AND LICENSING INC., Basking Ridge, NJ (US)

(21) Appl. No.: 13/442,915

(22) Filed: Apr. 10, 2012

(51) Int. Cl. G06Q 10/06

(52) U.S. Cl. 705/7.26

(57) ABSTRACT

A method, a device, and a non-transitory storage medium provide for receiving a user selection of an asset to be processed by an asset processing system; receiving a user selection of a type of asset processing order to be generated; identifying types of data to be obtained to generate an asset processing order, in response to receiving the type of asset processing order to be generated; obtaining order data that includes a work flow identifier; obtaining asset data that includes an asset identifier and asset characteristic data; obtaining at least one of ingest data, transform data, or distribution data; generating an asset processing order based on the obtained order data, the obtained asset data, and the at least one of the obtained ingest data, the obtained transform data, or the obtained distribution data; and transmitting the asset processing order and the asset to the asset processing system.

### BACKGROUND

Consumer demand for media is increasing. For example, consumers often watch and/or listen to various media at home, while traveling, at work, etc. As a result, the number of communication channels for delivering media content and the number of different types of devices for playing the content has also increased.

Asset providers are confronted with various challenges, such as, providing assets in various formats and distributing the assets to consumers. Asset providers may use an asset processing provider to accomplish this task.

### BRIEF DESCRIPTION OF THE DRAWINGS

FIG. 1 is a diagram illustrating an exemplary environment in which an exemplary embodiment of a communication layer to invoke an asset processing service may be implemented;

FIGS. 2A-2D are diagrams illustrating an exemplary process associated with the communication layer described herein;

FIG. 3 is a diagram illustrating exemplary components of an exemplary embodiment of one or multiple devices illustrated in FIG. 1;

FIG. 4 is a diagram illustrating exemplary data included in an exemplary embodiment of an asset processing order;

FIG. 5 is a diagram illustrating an exemplary embodiment of an asset provider device; and

FIGS. 6A and 6B is a flow diagram illustrating an exemplary process for generating an asset processing order.

### DETAILED DESCRIPTION

The following detailed description refers to the accompanying drawings. The same reference numbers in different drawings may identify the same or similar elements.

The term “asset” as used herein, may include, for example, content and metadata, content, or metadata. The term “content,” as used herein, may include for example, multimedia content (e.g., text-based content, audio and video such as a movie, a show, a television program, broadcast of a live event (e.g., sporting event, concert, etc.)), e-books, or another type of content or asset. Content may include, for example, time-shifted content, summaries of content, game content, episodic content, a segment of a full portion of content. Additionally, content may include user-generated content (e.g., videos, prints, etc.). The term “metadata,” as used herein, may include, for example, data or information (e.g., descriptive data, data indicating how content is to be displayed, copied, sold, etc.) pertaining to content. Content and metadata may be grouped as various entities. For example, a group of content and metadata may be considered a package or a group of packages may be considered a bundle.

According to an exemplary embodiment, a communication layer between asset provider devices and asset processing devices is provided. According to an exemplary embodiment, an asset provider device generates an asset processing order that allows the asset processing devices to process an asset according to the specifications of an asset provider. According to an exemplary embodiment, the asset processing order includes data to allow the asset processing devices to process the asset in an automated manner. In this regard, the communication layer provides, among other things, a streamline approach to process assets and distribute assets to media retailers, consumers, etc.

According to an exemplary embodiment, the asset provider device includes software that provides a user interface to permit a user (e.g., an asset provider, a consumer, etc.) to interactively generate the asset processing order. The asset provider device is described further below.

According to an exemplary embodiment, the asset processing order includes order data and asset data. According to an exemplary embodiment, the order data includes data pertaining to the asset provider. For example, according to an exemplary implementation, the order data includes authentication and/or authorization data (e.g., for accessing and using the asset processing service), account and/or billing data, and a work flow identifier that indicates an asset process. According to an exemplary embodiment, the asset data includes data pertaining to the asset. For example, according to an exemplary implementation, the asset data includes an asset identifier and asset characteristic data.

Additionally, according to an exemplary embodiment, the asset processing order includes asset processing data. For example, according to an exemplary implementation, the asset processing data includes ingestion data, transformation data, and/or distribution data that pertain(s) to the ingesting, the transforming, and/or the distributing of the asset. The asset processing order is described further below.

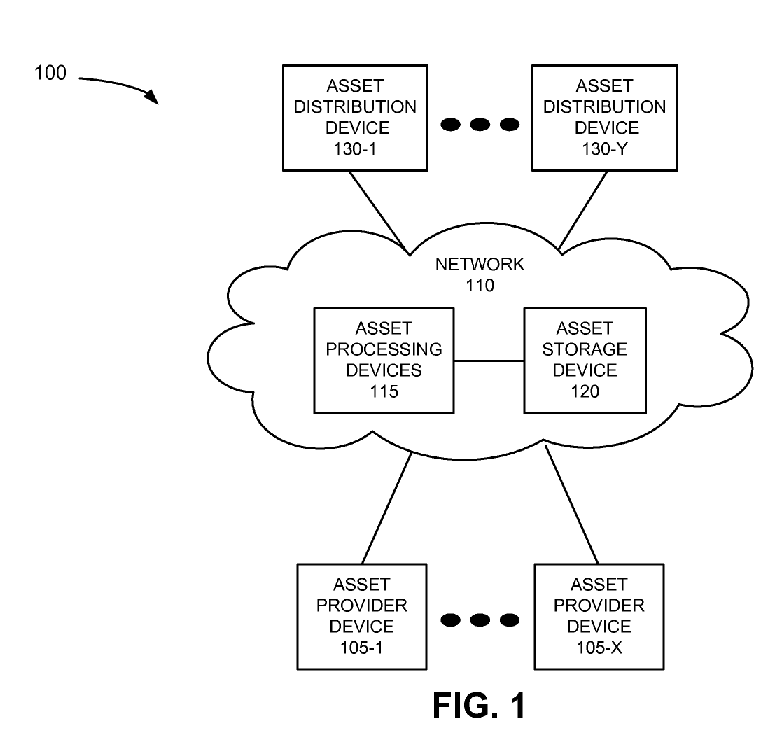

FIG. 1 is a diagram of an exemplary environment 100 in which an exemplary embodiment of the communication layer may be implemented. Referring to FIG. 1, environment 100 includes asset provider devices 105-1 through 105-X, in which X>1 (also referred to collectively as asset provider devices 105 and individually as asset provider device 105), a network 110 that includes asset processing devices 115 and an asset storage device 120, and asset distribution devices 130-1 through 130-Y, in which Y>1 (also referred to collectively as asset distribution devices 130 and individually as asset distribution device 130).

The number of devices and networks, and the configuration illustrated in environment 100 are exemplary. According to other embodiments, environment 100 may include additional devices, fewer devices, different devices, and/or a different configuration than those illustrated in FIG. 1. Additionally, or alternatively, environment 100 may include an additional network.

According to other embodiments, a single device may be implemented as multiple devices. According to other embodiments, multiple devices may be implemented as a single device. A device may be implemented according to a centralized computing architecture, a distributed computing architecture, or a cloud computing architecture (e.g., an elastic cloud, a private cloud, etc.). Additionally, a device may be implemented according to one or multiple network architectures (e.g., a client device, a server device, a peer device, or a combination thereof).

Also, according to other embodiments, one or multiple functions and/or processes described as being performed by a device may be performed by a different device, or some combination of devices, which may or may not include the device. Additionally, or alternatively, according to other embodiments, one or multiple functions and/or processes described as being performed by multiple devices may be performed by different devices, or a single device, etc.

Environment 100 may be implemented to include wired and/or wireless connections among the devices and network illustrated. A connection may be direct or indirect and may involve intermediary device(s) and/or network(s) not illustrated in FIG. 1.

Referring to FIG. 1, asset provider device 105 includes a device capable of communicating to asset processing devices 115 and asset storage device 120. According to an exemplary embodiment, asset provider device 105 is implemented as a user device. For example, asset provider device 105 may be implemented as a computational device (e.g., a computer, a terminal, etc.) or another type of device that has access to an asset (e.g., a smartphone, a set top box and television, or some other type of consumer device). According to such an implementation, asset provider device 105 includes software to permit a user to interactively generate an asset processing order. According to another exemplary embodiment, asset provider device 105 may be implemented as a network device. For example, asset provider device 105 may be implemented as a computational device (e.g., a computer, an application server device, a web device, etc.).

Asset provider device 105 may be associated with an asset provider. For example, an asset provider may represent one or multiple entities that create assets and wish to have their assets processed (e.g., transcoding, formatting, etc.), packaged, and distributed to other entities, such as consumers, retailers, etc. By way of example, an asset provider may be a movie studio, a television studio, a publisher, a game developer, a record label, an advertiser, or some other type of asset provider (e.g., a consumer, etc.).

Network 110 includes a network that is accessible to asset provider devices 105. Network 110 may include a wired network, an optical fiber network, and/or a wireless network. Network 110 may be implemented as a private network, a public network, a semipublic network, etc. Asset processing devices 115 includes devices that process assets. According to an exemplary embodiment, asset processing devices 115 provide an automated environment in which assets are ingested, transformed, packaged, and distributed. According to an exemplary embodiment, asset processing devices 115 process an asset based on a work flow model. For example, a work flow includes one or multiple work units that form a processing path through which an asset may flow. A work unit, for example, includes a particular function or operation. For example, a work unit may include a function or operation pertaining to ingesting, transforming, packaging, or distributing an asset. As previously described, an asset processing order may include a work flow identifier that identifies a work flow to permit processing of an asset in accordance with an asset provider's specification.

According to an exemplary embodiment, asset processing devices 115 are implemented as computational devices (e.g., computers) that include software to perform various asset processing. According to an exemplary embodiment, asset processing devices 115 includes an asset device (e.g., an asset order processing device) that interprets asset processing orders to permit the processing of assets, by asset processing devices 115, in accordance with the data provided in the asset processing order.

Asset storage device 120 includes a device that stores assets. According to an exemplary embodiment, asset storage device 120 is implemented as a mass storage device. According to an exemplary embodiment, asset storage device 120 includes frontend logic. For example, the frontend logic provides an interface for asset processing devices 115 and/or asset provider devices 105 to access, retrieve, store, delete, etc., assets stored by asset storage device 120. According to an exemplary embodiment, asset storage device 120 includes asset management logic to permit administrators to create and manage the storage of assets.

Asset distribution device 130 includes a device that receives assets from asset processing devices 115 and distributes the asset to various entities. According to an exemplary embodiment, asset distribution device 130 is implemented as a computational device (e.g., a computer, a gateway device, an edge device, etc.). Asset distribution device 130 may be associated with an asset distributor. For example, an asset distributor may include, for example, a television service provider, a retailer (e.g., online or not online), a movie warehouse, a game distributor, a user device, etc. An asset distributor may sell, rent, and/or provide assets to consumers and/or other entities.

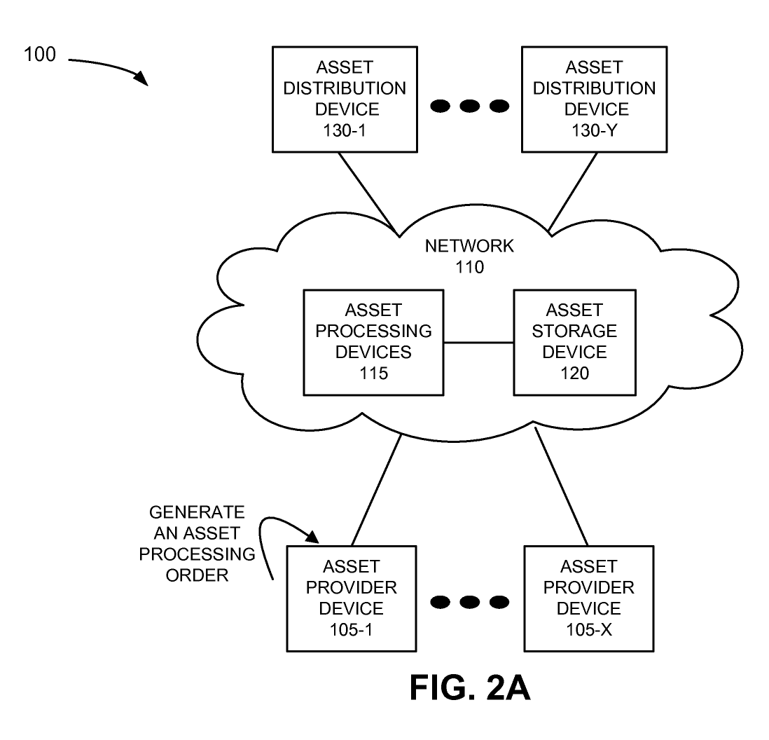

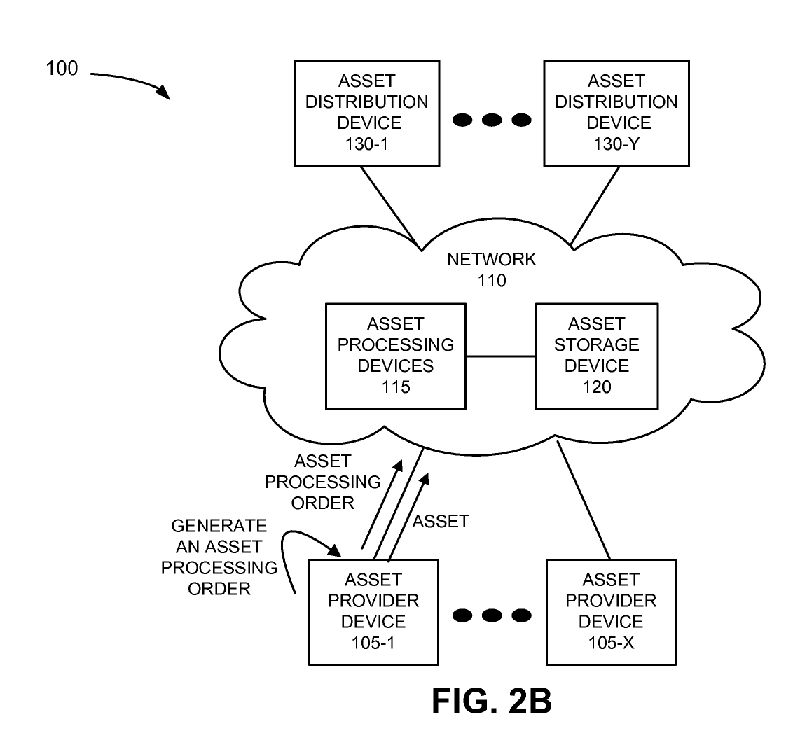

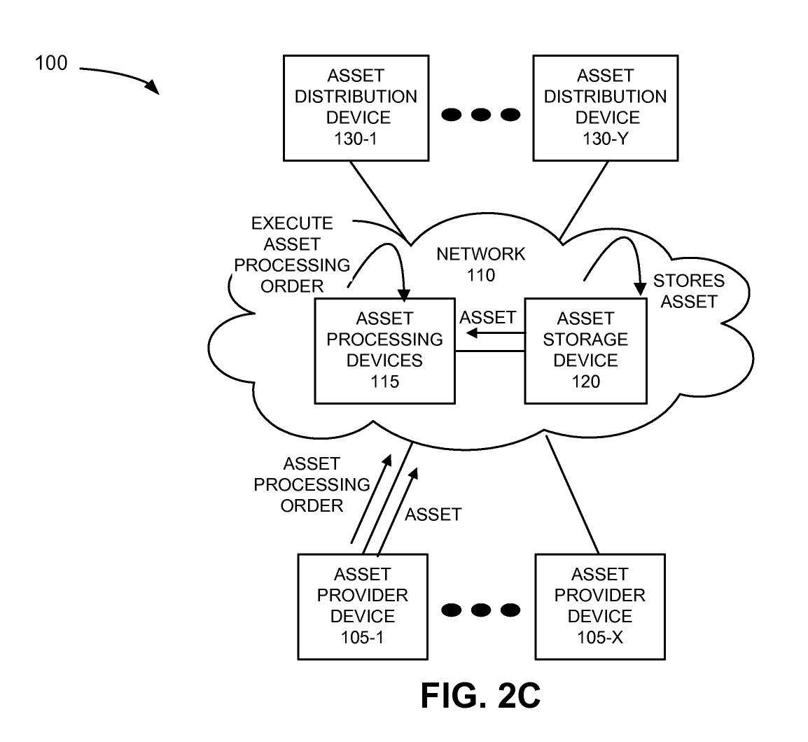

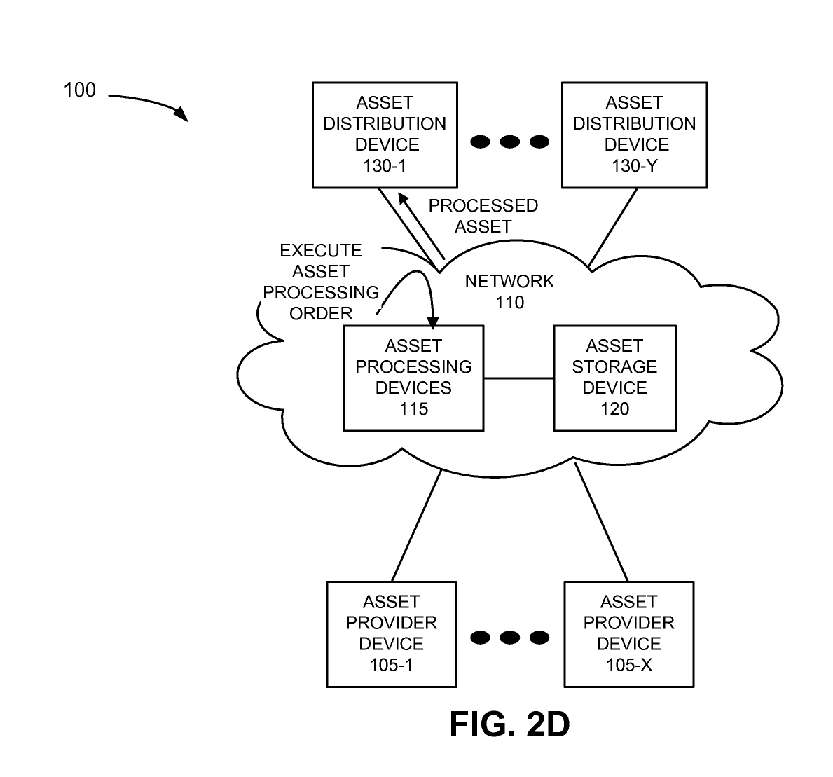

FIGS. 2A-2D are diagrams illustrating an exemplary process associated with the communication layer described herein. Referring to FIG. 2A, according an exemplary scenario, assume that an asset provider operates asset provider device 105-1 to generate an asset processing order. The asset processing order includes data to indicate what type of processing to the asset is to be performed. For example, according to this scenario, assume that the asset provider wishes the asset to be ingested, transformed, packaged, and distributed.

Referring to FIG. 2B, asset provider device 105 transmits an asset processing order to asset processing devices 115. Additionally, asset provider device 105 transmits an asset to asset storage device 120. Referring to FIG. 2C, asset storage device 120 stores the asset. Asset processing devices 115 interprets the asset processing order and executes the asset processing order. Referring to FIG. 2D, asset processing devices 115 transmits the processed asset to asset distribution device 130-1.

According to other embodiments, the process associated with the communication layer may be different. For example, push or pull communication may be used in providing an asset for asset processing or providing an asset for distribution.

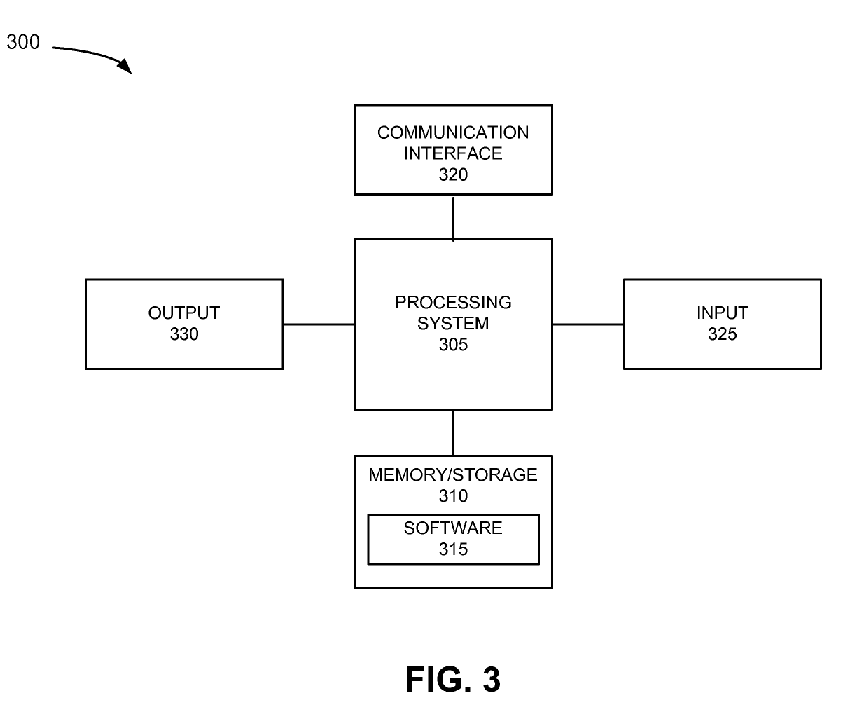

FIG. 3 is a diagram illustrating exemplary components of a device 300 that may correspond to one or multiple of the devices in environment 100. As illustrated, according to an exemplary embodiment, device 300 includes a processing system 305, memory/storage 310 including software 315, a communication interface 320, an input 325, and an output 330. According to other embodiments, device 300 may include fewer components, additional components, different components, and/or a different arrangement of components than those illustrated in FIG. 3 and described herein.

Processing system 305 includes one or multiple processors, microprocessors, data processors, co-processors, application specific integrated circuits (ASICs), controllers, programmable logic devices, chipsets, field programmable gate arrays (FPGAs), application specific instruction-set processors (ASIPs), system-on-chips (SoCs), central processing units (e.g., single or multiple cores), microcontrollers, and/or some other component or logic that may interpret and/or execute instructions and/or data. Processing system 305 may be implemented as hardware (e.g., a microprocessor, etc.), a combination of hardware and software (e.g., a SoC, an ASIC, etc.), may include one or multiple memories (e.g., memory/storage 310, etc.), etc.

Processing system 305 may control the overall operation or a portion of operation(s) performed by device 300. Processing system 305 may perform one or multiple operations based on an operating system and, various applications and/or programs (e.g., software 315). Processing system 305 may access instructions from memory/storage 310, from other components of device 300, and/or from a source external to device 300 (e.g., a network, another device, etc.).

Memory/storage 310 includes one or multiple memories and/or one or multiple other types of storage mediums. For example, memory/storage 310 may include a random access memory (RAM), a dynamic random access memory (DRAM), a read only memory (ROM), a programmable read only memory (PROM), a flash memory, a phase-change memory (PCM), and/or some other type of storing medium (e.g., a compact disk (CD), a digital versatile disk (DVD), etc.). Memory/storage 310 may include a hard disk (e.g., a magnetic disk, an optical disk, a magneto-optic disk, a solid state disk, etc.) or some other type of storage medium, along with a corresponding drive. Memory/storage 310 may be external to and/or removable from device 300, such as, for example, a Universal Serial Bus (USB) memory, a dongle, a hard disk, mass storage, off-line storage, etc. Memory/storage 310 may store data, software, and/or instructions related to the operation of device 300.

Software 315 may include software (e.g., an application, a program, firmware, etc.) that provides various services and/or functions. For example, with reference to asset provider device 105 and according to an exemplary embodiment, software 315 may provide a user interface to permit a user to generate an asset processing order, as described herein. Additionally, or alternatively, for example, with reference to other devices, components, etc., in environment 100, software 315 may include one or multiple applications, programs, etc., for performing processes, functions, operations, etc., that are described herein.

Communication interface 320 permits device 300 to communicate with other devices, networks, systems, etc., illustrated in environment 100. Communication interface 320 may include one or multiple wireless interfaces and/or wired interfaces. Communication interface 320 may include one or multiple transmitters, receivers, and/or transceivers. Communication interface 320 may operate according to one or multiple protocols, standards, and/or the like.

Input 325 may permit an input into device 300. For example, input 325 may include a keyboard, a mouse, a camera, a scanner, a microphone, a display, a touchpad, a button, a switch, an input port, voice recognition logic, fingerprint recognition logic, a web cam, and/or some other type of visual, auditory, tactile, etc., input component. Output 330 may permit an output from device 300. For example, output 330 may include a speaker, a display, a light, an output port, and/or some other type of visual, auditory, tactile, etc., output component.

As described herein, device 300 may perform processes in response to processing system 305 executing software instructions (e.g., software 315) stored by memory/storage 310. By way of example, the software instructions may be read into memory/storage 310 from another memory/storage 310 or from another device via communication interface 320. The software instructions stored by memory/storage 310 may cause processing system 305 to perform one or multiple processes described herein. Alternatively, for example, according to other implementations, device 300 may perform one or multiple processes described herein based on the execution of hardware (processing system 305, etc.), the execution of hardware and firmware, or the execution of hardware, software, and firmware.

According to an exemplary embodiment of the communication layer, the generation of an asset processing order depends on the asset provider having certain information. For example, an asset processing order includes a work flow identifier. The work flow identifier identifies the type of processing to be performed by asset processing devices 115. By way of example, a work flow identifier may correlate to processes, such as, ingesting, transforming, and distributing. Alternatively, for example, a work flow identifier may correlate to a process for ingesting, transforming, packaging, or distributing. The asset processing provider may provide work flow identifiers to the asset provider. The asset processing order may then include an appropriate work flow identifier that correlates to the desired asset processing service.

For purposes of ingestion and distribution, the asset provider will have inbound transport profiles and outbound transport profiles. The inbound transport profile includes data pertaining to where an asset is stored in asset storage device 120 and how the asset can be accessed for ingestion. For example, the inbound transport profile may include transport level data, such as, for example, a transport protocol, a hostname, a user identifier, and storage location data, such as, for example, a directory structure, etc. The outbound profile includes data pertaining to distributing assets to asset distribution devices 130. For example, the outbound profile includes transport level data and storage location data for distribution of a transformed asset.

Additionally, the asset provider will have stock keeping unit (SKU) data. For example, the stock keeping unit data may include data pertaining to the pricing, tracking, etc., of an asset.

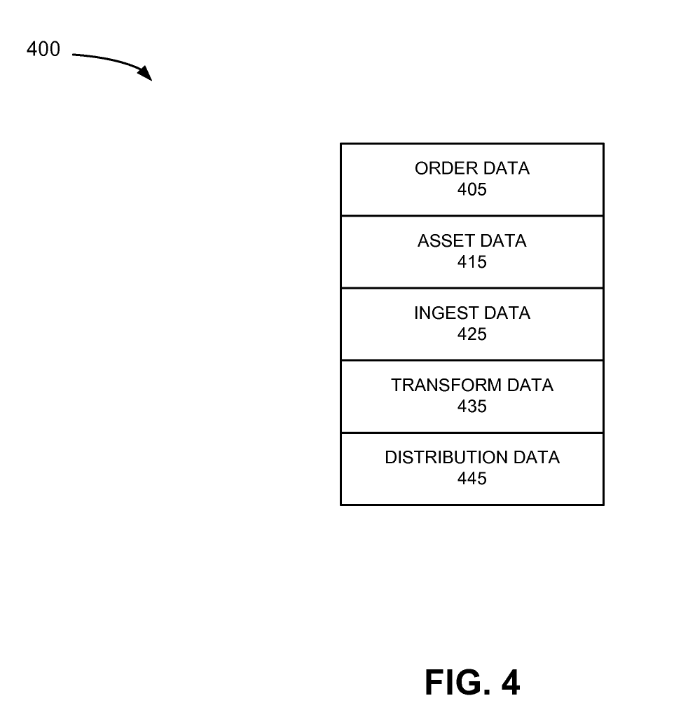

Described below is an exemplary asset processing order. FIG. 4 is a diagram illustrating an exemplary embodiment of an asset processing order. As illustrated, an asset processing order 400 includes order data 405, asset data 415, ingest data 425, transform data 435, and distribution data 445. According to other embodiments, the asset processing order may include fewer types of data. For example, an asset processing order may include order data 405, asset data 415 and, one or more of ingest data 425, transform data 435, or distribution data 445. In other words, an asset provider may transmit an asset processing request to just ingest the asset, or to ingest and transform the asset without distribution instructions, etc.

Order data 405 includes general data and work flow data pertaining to asset processing order 400. According to an exemplary implementation, order data 405 includes a system identifier, a billing code identifier, account name data, and a work flow identifier. For example, the system identifier may indicate a user(s) or a device(s). The system identifier may be used for authorization and/or authentication purposes to access and/or use asset processing services offered by asset processing devices 115. The billing code identifier may indicate, for example, a billing code. The account name data may indicate, for example, the name of a billed entity. The work flow identifier may indicate, for example, a work flow. As previously described, a work flow pertains to a processing path through which an asset flows in asset processing devices 115.

Order data 405 may include other types of data. For example, order data 405 may include a timestamp indicating when an asset processing order is sent, and order completion data pertaining to when the asset processing order is to be completed. Additionally, order data 405 may include special instruction data. For example, special instruction data may invoke human intervention in the processing of the asset.

Asset data 415 includes data pertaining to the asset. According to an exemplary implementation, asset data 415 includes an asset identifier and asset characteristic data. The asset identifier identifies an asset. The asset identifier may be established by the asset provider. The asset characteristic data includes data indicating a characteristic of the asset. For example, asset characteristic data may include asset name data that indicates the name of the asset, asset size data that indicates a size of the asset, asset duration data that indicates the duration of the asset (e.g., an audio/video asset), and/or other data that indicates an attribute of the asset (e.g., a resolution, a format, a language, a version, etc.).

Ingest data 425 includes data pertaining to the ingestion of the asset. According to an exemplary implementation, ingest data 425 includes an inbound transport profile and an asset reference. The inbound transport profile includes data as to how and where the asset can be obtained for ingestion. For example, the inbound transport profile includes transport level data and storage location data, as previously described. Depending on the method (e.g., push, pull) in which asset processing devices 115 obtain the asset for ingestion, the inbound transport profile may pertain to how and where the asset can be obtained for ingestion in relation to, for example, asset storage device 120, asset provider device 105, or some other device associated with the asset provider, the asset processing provider, or a third party. The asset reference correlates to the asset identifier included in order data 405.

Transform data 435 includes data pertaining to the transformation of the asset. According to an exemplary implementation, transform data 435 includes a transformation identifier, title data, SKU specification, and an edit decision list (EDL). The transformation identifier is an identifier of the transformed asset. The title indicates a title of the transformed asset. SKU specification includes data for building a SKU. For example, the SKU specification includes data pertaining to the pricing and tracking of the transformed asset. The SKU specification may also identify the technical information or specification needed to create a SKU. For example, the SKU specification may identify the target devices, information needed by a transcoding device to create the target (e.g., encoding format, ratio, frame rate, bitrate, etc.). The edit decision list includes transformation instructions. For example, the edit decision list may indicate to concatenate a first movie and a second movie, use a particular audio asset, downgrade the resolution (e.g., from 1080p to 1080i), provide a format (e.g., 16:9), and insert a bug. The edit decision list provides information in terms of asset and timecode to define transformation steps. The edit decision list may be in different formats, such as, for example, CMX3600, AAF, etc. In this way, a same workflow identifier, which identifies, for example, a transformation process, may transform multiple target assets based on the assets processed in an order and how a edit decision list defines their assembly.

Distribution data 445 includes data pertaining to the distribution of the asset. According to an exemplary implementation, distribution data 445 includes distributor name data, an outbound transport profile, packaging instruction data, an asset reference, and a transformation reference. Distributor name data identifies a distributor (e.g., an asset distributor, a consumer, etc.) and/or a distributor device (e.g., asset distributor device 130, user device, etc.). The outbound transport profile includes data as to how the asset is to be distributed and where the asset is to be distributed. For example, as previously described, the outbound transport profile includes transport level data for distributing the asset and storage location data for storing the asset. Depending on the method (e.g., push, pull) in which the asset is distributed, the outbound transport profile may pertain to, for example, asset distributor device 130, asset provider device 105, or some other device associated with the asset provider, a third party, etc.

Packaging instruction data includes data indicating the type of packaging for the asset. For example, packaging instruction data may indicate a particular type of SKU that is to be prepared for distribution, such as Spideman movie, MPEG-2, English, video-on-demand. The asset reference is the reference that correlates to the asset identifier included in asset data 415. The transformation reference is the reference that correlates to the transformation identifier included in transform data 435.

An example of an asset processing order is provided below. According to this example, the asset processing order is written in Extensible Markup Language (XML). According to other implementations, the asset processing order may be expressed in other suitable languages and/or formats.

Additionally, according to the example, below, the asset processing order includes data, information, files, and/or the like that are named. For example, as provided below, the transformation details include an EDLFileName, which names an EDL file. According to such an implementation, the asset processing order also includes the EDL file itself.

<Order Header>

<UserId>V121011</UserId>
<BillingId>989121</BillingId>
<AccountName>CPACC1</AccountName>
<WorkFlowName>WF_INGEST</WorkFlowName>

</OrderHeader>
<AssetDetails>

<Asset id = “spiderman-asset-01”>

<FileName> SPIDERMAN PART I.MOV</Filename>
<FileSize/>
<Duration/>

</Asset>
<Asset id = “spiderman-asset-02”>

<FileName> SPIDERMAN PART II.MOV</Filename>
<FileSize/>
<Duration/>

</Asset>

</AssetDetails>
<IngestDetails>

<InboundTransportProfile>TP3</InboundTransportProfile>
<Asset ref = “spiderman-asset-01”/>
<Asset ref = “spiderman-asset-02”/>

</IngestDetails>
<TransformationDetails>

<Transformation id = “transform-01”>
<Title> SPIDERMAN</Title>
<SKUSPECNAME>Brightcove MPEG4_H264_640x360_1mbps_{—}

29.97fps</SKUSPECNAME>

<EDLFileName>SPIDERMAN.EDL</EDLFileName>

</Transformation>

<Transformation id = “transform-02”>

<Title> SPIDERMAN</Title>
<SKUSPECName>Brightcove MOV_H264_640x360_1mbps

29.97fps</SKUSPECName>

<EDLFileName>SPIDERMAN.EDL</EDLFileName/>

</Transformation>
</TransformationDetails>
<DistributionDetails>

<Distribution>

<DMRName>DMR-01</DMRName>
<OutboundTransportProfile>TP1</OutboundTransportProfile>
<PackagingInstructions>package-01</PackagingInstruction>
<Asset ref = “spiderman-asset-01”/>
<Asset ref = “spiderman-asset-02/>
<Transformation ref = “transform-01”/>

</Distribution>
<Distribution>

<DigitalMediaRetailerName>DMR-01</DigitalRetailerName>
<OutBoundTransportProfile>TP2</OutBoundTransportProfile>
<PackagingInstructions>package-02</PackagingInstruction>
Asset ref = “spiderman-asset-01”/>
Asset ref = “spiderman-asset-02”/>
Transformation ref = “transform-02”/>

</Distribution>

</DistributionDetails>

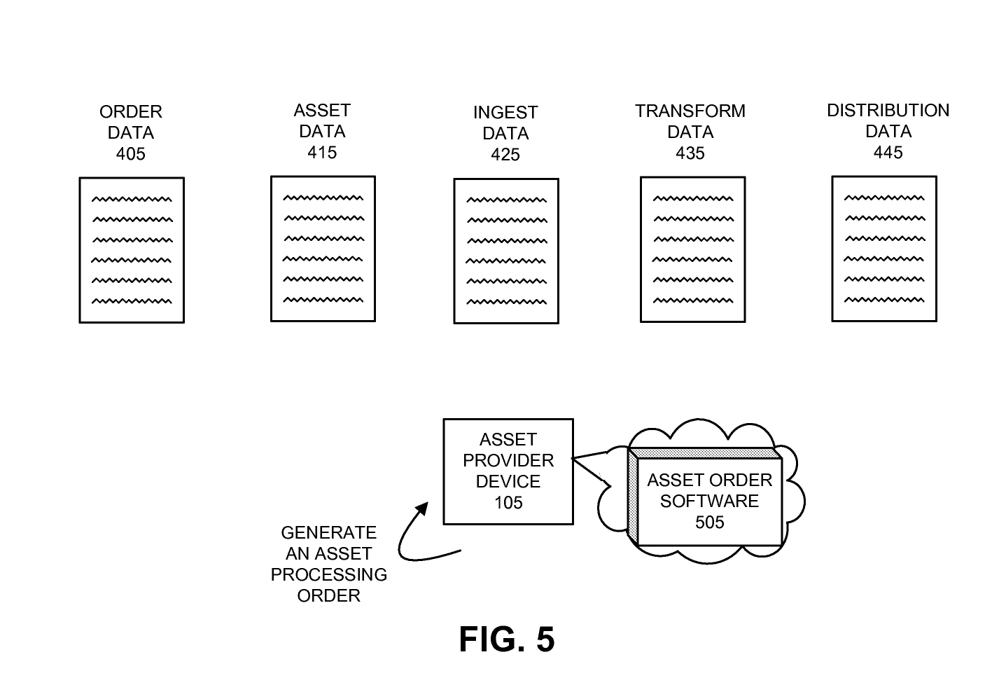

As previously described, according to an exemplary embodiment, asset provider device 105 includes software that provides a user interface to permit a user to generate an asset processing order. For example, referring to FIG. 5, asset provider device 105 includes asset order software 505 that provides a user interface to generate an asset processing order. Asset order software 505 may include a graphical-based and/or a textual-based user interface. Asset order software 505 may generate the asset processing order based on data entered by the user, pre-stored data, and/or data generated by asset order software 505. Asset order software 505 includes the functionality to obtain the data (e.g., order data 405, asset data 415, ingest data 425, transform data 435, distribution data 445) to generate the asset processing order.

As previously described, according to an exemplary embodiment, an asset provider may have certain information to generate an asset processing order. For example, the asset provider may have one or multiple work flow identifiers, inbound transport profiles, outbound transport profiles, and SKU data. According to other embodiments, additional, different, and/or fewer types of data may be used to generate an asset processing order. For example, if the asset provider is a consumer, the asset provider may not use SKU data. Additionally, or alternatively, if the asset provider does not wish to distribute the asset. Rather, the processed asset is sent back to the asset provider. According to a pull method, one transport profile may be sufficient for obtaining the asset for ingestion and distributing the asset (e.g., from and to the same device and storage location). Based on the use of these types of data, asset order software 505 includes the functionality to access and/or use these types of data to generate the asset processing order.

A further description of asset order software 505 and the generation of an asset processing order are provided below. According to other embodiments, asset order software 505 may generate the asset processing order based on different functions or operations than those described herein. In this regard, the description of asset order software 505 is not intended to be an exhaustive treatment on the various ways in which data may be obtained for generating the asset processing order.

With reference to order data 405, asset order software 505 may obtain portions of order data 505 during a setup procedure. For example, the general data (e.g., a system identifier, a billing code, account data, etc.) may be entered by a user. Additionally, asset processing software 505 may prompt the user or provide an interactive user interface to allow the user to select the work flow identifier, include special instructions, order completion data, etc.

With reference to asset data 415, asset order software 505 may obtain portions of asset data 415 based on user input, pre-stored data, and/or data generated by asset order software 505. For example, according to an exemplary implementation, asset order software 505 may prompt the user or provide an interactive user interface to allow the user to enter asset characteristic data (e.g., asset size, asset duration, format, language, etc.). According to another exemplary implementation, asset provider device 105 or some other device may store metadata associated with an asset, which includes some or all of the asset characteristic data. Asset order software 505 may obtain the asset characteristic data based on the metadata. According to yet another exemplary implementation, asset order software 505 may obtain asset characteristic data based on the asset. For example, when the user selects the asset to be processed, asset order software 505 may identify asset characteristic data based on the asset file. For example, asset order software 505 may elicit the name of the asset, the format of the asset (e.g., from the extension), the size of the asset (e.g., properties data associated with the asset), etc. As previously described, asset data 415 may include an asset identifier. According to an exemplary implementation, asset order software 505 may prompt the user or provide an interactive user interface to allow the user to enter an asset identifier. Alternatively, according to an exemplary implementation, asset order software 505 may automatically generate an asset identifier (e.g., a unique string) based on a string randomizer function.

With reference to ingest data 425, asset order software 505 may obtain portions of ingest data 425 based on user input and pre-stored data. For example, according to an exemplary implementation, asset order software 505 may prompt the user or provide an interactive user interface to allow the user to select an inbound transport profile. Asset order software 505 may obtain the selected inbound transport profile (e.g., pre-stored data) to generate the asset processing order. Asset order software 505 may automatically obtain the asset identifier. According to another exemplary implementation, asset order software 505 may provide a user interface to allow the user to enter inbound transport profile data.

With reference to transform data 435, asset order software 505 may obtain portions of transform data 435 based on user input and pre-stored data. For example, according to an exemplary implementation, asset order software 505 may prompt the user or provide an interactive user interface to allow the user to select a SKU specification and an edit decision list. Asset order software 505 may obtain the SKU specification and the edit decision list (e.g., pre-stored data) to generate the asset processing order. According to another exemplary implementation, asset order software 505 may provide a user interface to allow the user to enter SKU specification data and/or edit decision list data. According to an exemplary implementation, asset order software 505 provides a user interface to allow the user to enter a title. According to an exemplary implementation, asset order software 505 provides a user interface to allow the user to enter a transformation identifier, or alternatively, asset order software 505 may automatically generate a transformation identifier (e.g., a unique string). For example, asset order software 505 may use the asset identifier as a seed to generate the transformation identifier.

With reference to distribution data 445, asset order software 505 may obtain portions of distribution data 445 based on user input and pre-stored data. For example, according to an exemplary implementation, asset order software 505 may prompt the user or provide an interactive user interface to allow the user to select an outbound transport profile. Asset order software 505 may obtain the selected outbound transport profile (e.g., pre-stored data) to generate the asset processing order. According to another exemplary implementation, asset order software 505 may provide a user interface to allow the user to enter outbound transport profile data. Asset order software 505 may automatically obtain the asset identifier and the transformation identifier. According to an exemplary implementation, asset order software 505 may prompt the user or provide an interactive user interface to allow the user to select or enter packaging instructions. According to an exemplary implementation, asset order software 505 may prompt the user or provide an interactive user interface to allow the user to select or enter a distributor identifier.

As previously described, an asset processing order may not always include each of order data 405, asset 415, ingest data 425, transform data 435, and distribution data 445. For example, a user may wish to have only ingestion of an asset take place. According to an exemplary implementation, asset order software 505 may include a user interface to allow the user to indicate a type of asset processing order (e.g., an ingestion asset order, an ingestion and transformation asset order, etc.) to allow asset order software 505 to recognize and obtain data to generate the asset processing order.

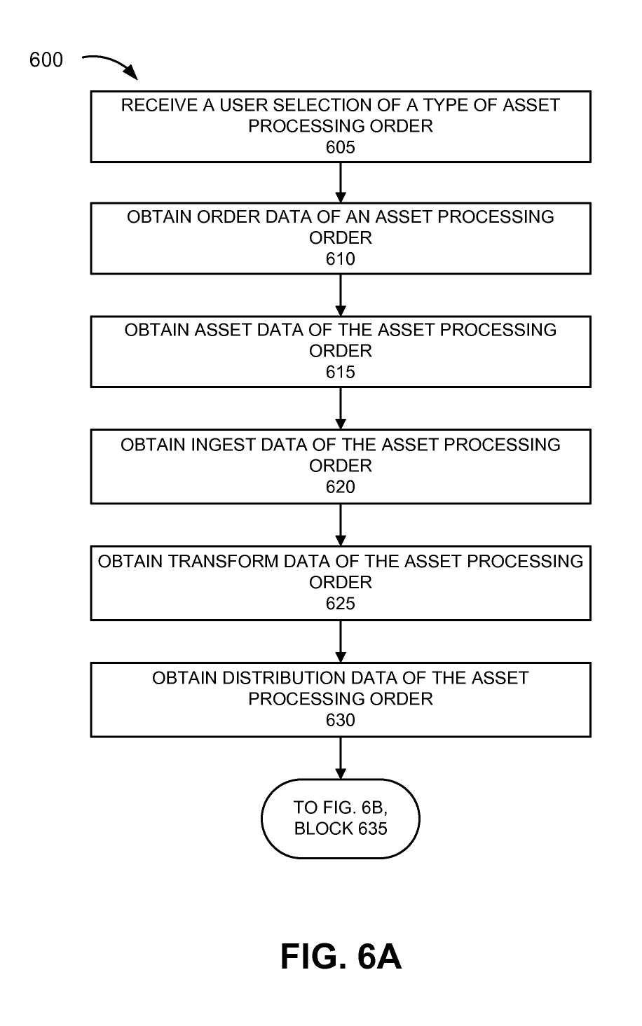

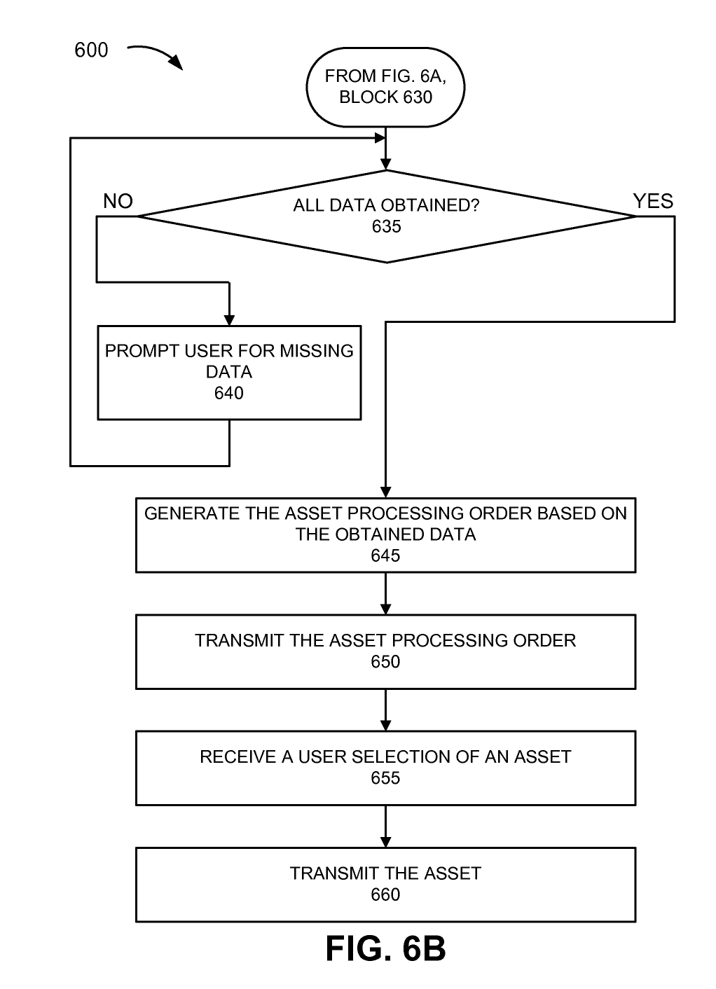

FIGS. 6A and 6B is a flow diagram illustrating an exemplary process 600 for generating an asset processing order. According to an exemplary embodiment, process 600 is performed by asset provider device 105 executing asset order software 505.

According to this example, process 600 provides for generating an asset processing order that includes ingestion, transformation, and distribution of an asset. According to other examples, the process for generating the asset processing order may be different in view of the type of asset processing order and the data to be obtained to generate that type of asset processing order.

Referring to FIG. 6A, in block 605, a user selection of a type of asset processing order is received. For example, asset provider device 105 receives a user selection, via a user interface provided by asset order software 505, of a type of asset processing order. As previously described, a user may wish to have only certain asset processes performed by asset processing devices 115. Asset order software 505 may include a user interface to allow the user to enter or select a type of asset processing order. According to this example, the user enters or selects an asset processing order that provides for the ingestion, transformation, and distribution of an asset. Based on the user selection of the type of asset processing order, asset order software 505 identifiers what type of data is to be obtained to generate the asset processing order.

In block 610, order data of an asset processing order is obtained. For example, as previously described, asset order software 505 obtains order data 405. According to an exemplary implementation, order data 405 includes general data and a work flow identifier. According to other implementations, as previously described, order data 405 may include other types of data (e.g., order completion data, special instructions, etc.). Asset order software 505 provides a user interface to allow the user to enter or select a work flow identifier of order data 405. Additionally, the general data of order data 405 may be obtained during a setup procedure or asset order software 505 provides a user interface to obtain the general data from the user.

In block 615, asset data of the asset processing order is obtained. For example, as previously described, asset order software 505 obtains asset data 415. According an exemplary implementation, asset data 415 includes an asset identifier and asset characteristic data. As previously described, asset order software 505 obtains asset data 415 based on user input, pre-stored data, and/or data generated by asset order software 505.

In block 620, ingest data of the asset processing order is obtained. For example, as previously described, asset order software 505 obtains ingest data 425. According to an exemplary implementation, ingest data 425 includes an inbound transport profile and an asset reference. As previously described, asset order software 505 obtains ingest data 425 based on user input and pre-stored data.

In block 625, transform data of the asset processing order is obtained. For example, as previously described, asset order software 505 obtains transform data 435. According to an exemplary implementation, transform data 435 includes a SKU specification, an edit decision list, an asset title, a transformation identifier, and an asset identifier. As previously described, asset order software 505 obtains transform data 435 based on user input, pre-stored data, and/or data generated by asset order software 505.

In block 630, distribution data of the asset processing order is obtained. For example, as previously described, asset order software 505 obtains distribution data 445. According to an exemplary implementation, distribution data 445 includes a distributor identifier, an outbound transport profile, packaging instructions, an asset reference and a transformation reference. As previously described, asset order software 505 obtains distribution data 445 based on user input and pre-stored data.

Referring to FIG. 6B, in block 635, it is determined whether all data is obtained. For example, asset order software 505 determines whether all data for generating the asset processing order is obtained based on the type of asset processing order and the obtained data.

If it is determined that all data is not obtained (block 635-NO), then the user is prompted for missing data (block 640). For example, asset order software 505 may navigate the user to a user interface to provide any missing data. Process 600 continues to block 635.

If it is determined that all data is obtained (block 635-YES), the asset processing order is generated based on the obtained data (block 645). For example, asset order software 505 generates the asset processing order based on order data 405, asset data 415, ingest data 425, transform data 435, and distribution data 445. By way of example, asset order software 505 may generate an XML-based asset processing order, as previously described.

In block 650, the asset processing order is transmitted. For example, asset provider device 105 transmits the asset processing order to asset processing devices 115.

In block 655, a user selection of an asset is received. For example, asset order software 505 provides a user interface to allow the user to select the asset to be processed.

In block 660, the asset is transmitted. For example, asset provider device 105 transmits the asset to asset storage device 120.

Although FIGS. 6A and 6B illustrate an exemplary process for generating an asset processing order, according to other embodiments, the process may include additional operations, fewer operations, and/or different operations than those illustrated and described.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

While a series of blocks has been described with regard to an exemplary process illustrated in FIGS. 6A and 6B, the order of the blocks may be modified according to other embodiments. In addition, non-dependent blocks may be performed parallel. Furthermore, other processes described in this description may be modified and/or non-dependent operations may be performed in parallel.

The exemplary embodiments described herein may be implemented in many different forms of software, firmware, and/or hardware. For example, a process or a function may be implemented as “logic” or as a “component.” This logic or this component may include, for example, hardware (e.g., processing system 305, etc.) or a combination of hardware and software (e.g., software 315). The embodiments have been described without reference to a specific software code since the software code, which when executed by hardware, can be designed to implement the embodiments based on the description herein.

The exemplary embodiments described herein may be implemented as a non-transitory storage medium that stores software. A non-transitory storage medium may be implemented as one or more of the storage media described above in relation to memory/storage 315. The non-transitory storage medium may also include other data and/or information, such as a data file, a data structure, a program module, etc. The software may include instructions, which may be implemented as, for example, machine code, such as produced by a compiler and/or files comprising higher level code that may be executed by a computational device using, for example, an interpreter.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the specification and/or drawings should be construed as critical or essential to the exemplary embodiments described herein unless explicitly described as such.

1. A method comprising:
receiving, by a device, a user selection of an asset to be processed by an asset processing system;
receiving, by the device, a user selection of a type of asset processing order to be generated;
identifying, by the device, types of data to be obtained to generate an asset processing order, in response to receiving the type of asset processing order to be generated;
obtaining, by the device, order data that includes a work flow identifier that identifies a process flow to be applied to the asset;
obtaining, by the device, asset data that includes an asset identifier that identifies the asset and asset characteristic data that includes data that indicates one or more characteristics of the asset;
obtaining, by the device, at least one of ingest data, transform data, or distribution data, wherein the ingest data includes data indicating how the asset is to be ingested and where the asset is located, wherein the transform data includes transform instructions to be applied to the asset, and wherein the distribution data includes data indicating where the asset is to be distributed;
generating, by the device, the asset processing order based on the obtained order data, the obtained asset data, and the at least one of the obtained ingest data, the obtained transform data, or the obtained distribution data; and
transmitting, by the device, the asset processing order and the asset to the asset processing system.

2. The method of claim 1, wherein the obtaining the asset data includes generating the asset identifier that identifies the asset.

3. The method of claim 1, wherein the obtaining the ingest data includes obtaining an inbound transport profile that includes transport level data and storage location data that indicates where the asset can be obtained, by the asset processing system, for ingestion.

4. The method of claim 1, wherein the obtaining the order data includes receiving user selections of account data and billing data pertaining to the use of the asset processing system.

5. The method of claim 1, wherein the transform data includes a stock keeping unit specification that includes data for building a stock keeping unit pertaining to the asset and wherein the transform data includes an edit decision list that includes transform instructions.

6. The method of claim 1, wherein the obtaining the distribution data includes obtaining an outbound transport profile that includes transport level data and storage location data that indicates where the asset is to be distributed.

7. The method of claim 1, wherein the obtaining the distribution data includes obtaining packaging instructions, wherein the packaging instructions indicate a particular stock keeping unit that is to be generated, by the asset processing system, for distribution.

8. The method of claim 1, further comprising:
storing one or more work flow identifiers that identify one or more work flows that the asset processing system performs to an asset.

9. The method of claim 1, wherein the asset includes content and metadata, and the content includes audio/visual content.

10. A device comprising:
a communication interface;
a memory storing instructions; and
a processor to execute the instructions to:
receive a user selection of an asset to be processed by an asset processing system;
receive a user selection of a type of asset processing order to be generated;
identify types of data to be obtained to generate an asset processing order, in response to the user selection of the type of asset processing order to be generated;
obtain order data that includes a work flow identifier that identifies a process flow to be applied to the asset;
obtain asset data that includes an asset identifier that identifies the asset and asset characteristic data that includes data that indicates one or more characteristics of the asset;
obtain at least one of ingest data, transform data, or distribution data, wherein the ingest data includes data indicating how the asset is to be ingested and where the asset is located, wherein the transform data includes transform instructions to be applied to the asset, and wherein the distribution data includes data indicating where the asset is to be distributed;
generate the asset processing order based on the obtained order data, the obtained asset data, and the at least one of the obtained ingest data, the obtained transform data, or the obtained distribution data; and
transmit, via the communication interface, the asset processing order and the asset to the asset processing system.

11. The device of claim 10, wherein, when obtaining the asset data, the processor executes the instructions to:
generate the asset characteristic data based on property information associated with the asset.

12. The device of claim 10, wherein, when obtaining the ingest data, the processor executes the instructions to:
obtain an inbound transport profile that includes transport level data and storage location data that indicates where the asset can be obtained, by the asset processing system, for ingestion.

13. The device of claim 10, wherein, when obtaining the distribution data, the processor executes the instructions to:
provide a user interface to permit a user to enter or select an distributor identifier that identifies a distributor or a distribution device.

14. The device of claim 10, wherein the transform data includes a stock keeping unit specification that includes data for building a stock keeping unit pertaining to the asset and wherein the transform data includes an edit decision list that includes transform instructions

15. The device of claim 10, wherein, when obtaining the distribution data, the processor executes the instructions to:
obtain packaging instructions, wherein the packaging instructions indicate a particular stock keeping unit that is to be generated, by the asset processing system, for distribution.

16. The device of claim 10, wherein, when obtaining the transform data, the processor executes the instructions to:
generate a transformation identifier that identifies a transformed asset.

17. A non-transitory storage medium comprising instructions executable by a computational device, the instructions comprising instructions to:
receive a user selection of an asset to be processed by an asset processing system;
receive a user selection of a type of asset processing order to be generated;
identify types of data to be obtained to generate an asset processing order, in response to the user selection of the type of asset processing order to be generated;
obtain order data that includes a work flow identifier that identifies a process flow to be applied to the asset;
obtain asset data that includes an asset identifier that identifies the asset and asset characteristic data that includes data that indicates one or more characteristics of the asset;
obtain at least one of ingest data, transform data, or distribution data, wherein the ingest data includes data indicating how the asset is to be ingested and where the asset is located, wherein the transform data includes transform instructions to be applied to the asset, and wherein the distribution data includes data indicating where the asset is to be distributed;
generate the asset processing order based on the obtained order data, the obtained asset data, and the at least one of the obtained ingest data, the obtained transform data, or the obtained distribution data; and
transmit the asset processing order and the asset to the asset processing system.

18. The non-transitory storage medium of claim 17, wherein the instructions to obtain the ingest data further comprise instructions to:
obtain an inbound transport profile that includes transport level data and storage location data that indicates where the asset can be obtained, by the asset processing system, for ingestion.

19. The non-transitory storage medium of claim 17, wherein the transform data includes a stock keeping unit specification that includes data for building a stock keeping unit pertaining to the asset and wherein the transform data includes an edit decision list that includes transform instructions.

20. The non-transitory storage medium of claim 17, wherein the instructions to obtain the distribution data further comprise instructions to:
obtain an outbound transport profile that includes transport level data and storage location data that indicates where the asset is to be distributed.
